(19) United States
(12) Patent Application Publication
(10) Pub. No.: US 2012/0039431 A1
(43) Pub. Date: Feb. 16, 2012

(54) Process for fused neutron nuclear chain reactions

(76) Inventor: Willard H. Schmidt, Albuquerque, NM (US)

(21) Appl. No.: 12/806,387

(22) Filed: Aug. 12, 2010

(51) Int. Cl. G21C 3/02

(52) U.S. Cl. 376/409; 976/DIG. 38

(57) ABSTRACT

Fused neutron particles from a multi-neutron particle generator are injected into atomic nuclei that have a core with groups of fused neutron pairs. Nuclear fusion reactions between injected multi-neutron particles and atomic core neutron particle pairs produce binding energy which causes atomic nuclei to fission. Consequently, more binding energy is released and fused neutron particle pairs are ejected from the nucleus. The ejected fused neutron particle pairs then enter nuclei of other atoms to cause nuclear fusion and nuclear fission reactions. More binding energy and more fused neutron particle pairs are released from the nuclei. This is a chain reaction process that can produce nuclear binding energy from almost any element as fuel.

### BACKGROUND OF THE INVENTION

This patent application is subsequent to applications “Neutron and Multi-Neutron Generator”, dated Apr. 22, 2010, and “Solid Iron Solenoid Neutron Initiator for Nuclear Reactor”, dated Feb. 12, 2009.

The nuclear fission process was discovered in 1938 by Otto Hahn, Fritz Strassmann, and Lise Meitner at the Kaiser Wilhelm Institute in Berlin Germany. Thermal neutrons injected into isotopes of uranium-235 or plutonium-239 cause the atomic nucleus to break apart, or fission. Large amounts of binding energy and several neutrons are released as a result of fission. The release of neutrons from fission permits a chain reaction process in which these neutrons enter other atomic nuclei and start the fission process all over again. Nuclear power plants use the nuclear fission process to produce energy and generate electricity.

Nuclear fusion processes occur in nuclear reactions when two nuclear particles join together to form a single particle. Binding energy is released because the mass of the fused particle is less than the sum of the masses of the constituent particles. This is in accord with Einstein's mass-energy equivalence principal. Hydrogen thermonuclear reactions occur when protons are fused together under high temperature and high pressure conditions. These nuclear fusion reactions occur in the sun and in certain types of nuclear weapons.

### BRIEF SUMMARY OF THE INVENTION

In the subject process for fused neutron chain reactions, fused multi-neutron particles are injected into atomic nuclei where nuclear fusion reactions occur between the injected fused neutron particles and fused neutron particle pairs in the atomic nuclei. These nuclear fusion reactions within the atomic nuclei produce large amounts of nuclear binding energy. This energy is sufficient to cause atomic nuclei to fission. Consequently, more nuclear binding energy is produced. Fused neutron pairs from within the fissioned nuclei are ejected. It is these fused neutron particles that enter other atomic nuclei to initiate further nuclear fusion reactions and nuclear fission reactions. The result is a series of fused neutron chain reactions. The large amount of nuclear binding energy released makes this fused neutron chain reaction process ideal for many different industrial and commercial applications.

Drawings are not submitted with this application because the above description of the subject process is sufficient.

I claim:

1. A fused neutron nuclear chain reaction process for production of energy.

2. Injection of fused multi-neutron particles into atomic nuclei of claim 1.

3. Nuclear fusion reactions between injected fused neutron particles of claim 1, and fused neutron particle pairs within atomic nuclei of elements.

4. Production of nuclear binding energy of claim 1 from nuclear fusion reactions between injected fused neutron particles and fused neutron particle pairs within atomic nuclei of elements.

5. Nuclear fission of atomic nuclei of claim 1 due to binding energy from nuclear fusion reactions between injected fused neutron particles and fused neutron particle pairs within atomic nuclei of elements.

6. Ejection of fused neutron particle pairs from nuclei of claim 1 due to binding energy from nuclear fusion reactions between injected fused neutron particles and fused neutron particle pairs within atomic nuclei.

7. Injection of ejected fused neutron particle pairs of claim 1 into other atomic nuclei of elements.

8. Nuclear fusion reactions between ejected fused neutron particle pairs of claim and fused neutron particle pairs within other nuclei of elements.

9. Production of nuclear binding energy from nuclear fusion reactions between ejected fused neutron particle pairs of claim 1 and fused neutron particle pairs within other nuclei of elements.

10. Release of nuclear binding energy from nuclear fusion reactions between ejected fused neutron particle pairs of claim 1 and fused neutron particle pairs within other nuclei of elements, and subsequent ejection of fused neutron particle pairs from within other nuclei of elements to complete the nuclear neutron fusion chain reaction cycle.

11. The fused neutron nuclear chain reaction process of claim 1 can produce nuclear binding energy from almost any element as nuclear fuel.
